(19) United States
(12) Patent Application Publication
(10) Pub. No.: US 2005/0212353 A1
(43) Pub. Date: Sep. 29, 2005

(54) Corrosion and heat resistant coating for anti-lock brake rotor exciter ring

(76) Inventor: Nirmal M. Tolani, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/072,952

(22) Filed: Mar. 3, 2005

Related U.S. Application Data
(60) Provisional application No. 60/556,247, filed on Mar. 25, 2004.

(51) Int. Cl. B60T 17/00

(52) U.S. Cl. 303/1

(57) ABSTRACT

A rotational element for a wheel comprising brake rotor for a motor vehicle anti-lock brake system. The rotor is selectively coated with highly corrosion and wear resistant coating material such as chrome-nickel-iron alloys or ceramic oxides. The coating only need be applied in the anti-lock brake system exciter ring area of the rotor. A thermal spray such as flame spray, plasma-arc spray that forms a strong bond with the exciter ring base material, will apply the coating to the substrate material of the ring.

This document claims priority of provisional patent application Ser. No. 60/556,247, filed 25 Mar. 2004.

### BACKGROUND OF THE INVENTION

1. Field of the Invention

The present invention relates to motor vehicle brake systems and more particularly to a high performance corrosion and heat resistant coated anti-lock brake rotor exciter ring for a motor vehicle anti-lock brake system.

2. Description of the Problem

Brake units for motor vehicles should provide smooth braking with reasonable service life. This need has been met with disk brake rotors made from relatively inexpensive gray iron castings. Gray iron is however highly susceptible to corrosive attack, particularly in the operating environment of vehicles where brake components are open to the air, subject to substantial transient heating and exposed to water and salt water spray. In regular use, the working surfaces of the disks are rubbed clean by contact with the disk pads, which are typically made of a composite material and which rub off corroded areas. However other areas of the brake disks are not swept by the brake pads and thereby cleaned of corrosion. Prior to anti-lock braking systems, such concerns were not paramount with brakes, which were frequently in use, since the rotor is a regularly replaced part and the remaining areas subject to attack were non-critical.

With the advent of anti-lock braking systems other sections of the disk brake rotor can take on importance. Among other sections of a typical disk rotor of mechanical importance is an anti-lock brake system exciter ring, which has typically been cast as one piece with the rotor. The exciter ring is a cylindrical section of the rotor having a common axis of rotation with the rotor. A plurality of teeth are positioned in a ring, flat in the plane of rotation of the rotor and outwardly oriented on the exterior of the ring to pass closely by a stationary sensor. The stationary sensor is a variable reluctance sensor, which generates an electrical pulse train as a function of the varying magnetic flux leakage between the sensor head and the exciter ring. The frequency of the resulting electrical pulse train indicates the rotational speed of the wheel on which the rotor is mounted. The generation of clean pulse train is greatly aided by having teeth of uniform shape, size and spacing. Corrosion can greatly compromise all of these factors, resulting in difficulty in detecting the passage of teeth and gaps and resulting in a corrupted pulse train.

It is known that coating parts suppresses corrosion. Corrosion protection coatings can be used such as that described in U.S. Pat. No. 5,569,543 and those supplied by Magni Corp., including the Magni 109 and Magni 111 coatings. Such coatings can be easily compromised when applied to exciter rings since the sensor usually needs to pass within very close proximity to the teeth and, consequently, the chance exists for removal of the coating from the teeth, which again leaves the teeth exposed to corrosive agents. In addition, such coatings are relatively expensive and their long term durability under all of the widely varying conditions of vehicle use is not well known. Current proprietary inorganic coatings used do not last the expected life of the brake rotor, therefore do not solve the problem. The high performance coating is expected to last for the life of the rotor. Also this coating will improve the dissipation of heat during brake applications.

It is known to make disk rotors out of more than one material, although no application of such an approach to solving the problems of ABS exciter rings is known to the inventor. German Laid Open Application 42 37 655 describes a brake disk for a motor vehicle disk brake system. The rotor comprises two abrasion rings, including an inner ring made of iron and an outer ring made of a composite fiber material. The rings are bonded to one another, preferably using rivets. The application mentions the possibility of casting the iron disk onto the composite fiber disk. The application is not directed primarily to corrosion problems but rather to improving weight balance, reducing the potential for cracking and reducing brake vibration. It is also known to make an anti-lock brake system for motor vehicle with a cast iron rotor that is symmetrically adhering to exciter ring made of corrosion resistant ferritic stainless steel having melting point higher than cast iron motor as described in U.S. Pat. No. 6,568,512, which was also invented by Applicant and is under common ownership with this application.

Thermal spray coatings have been used in the prior art for applying durable exterior surfaces to materials although not in motor vehicle brake system applications. As described in the Metals Handbook (Volume 5, Ninth Edition, Published by American Society for Metals, Metals Park, Ohio), thermal spray is a generic term for a group of commonly used processes for depositing metallic and non-metallic coatings. These processes, sometimes known as metallizing, are flame spray, plasma-arc spray, and electric arc spray.

### SUMMARY OF THE INVENTION

According to the invention there is provided a rotational element for a wheel comprising brake rotor for a motor vehicle anti-lock brake system. The rotor is selectively coated with highly corrosion resistant and wear resistant coating material such as chrome-nickel-iron alloys or ceramic oxides. The coating only need be applied in the anti-lock brake system exciter ring area of the rotor. A thermal spray such as flame spray, plasma-arc spray, or electric spray arc that forms a strong bond with the exciter ring base material, will apply the coating to the substrate material of the ring.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a schematic illustration of a vehicle equipped with anti-lock brake systems.

FIG. 2 is a perspective view of one embodiment of a disk rotor made in accordance with the invention.

### DETAILED DESCRIPTION OF THE INVENTION

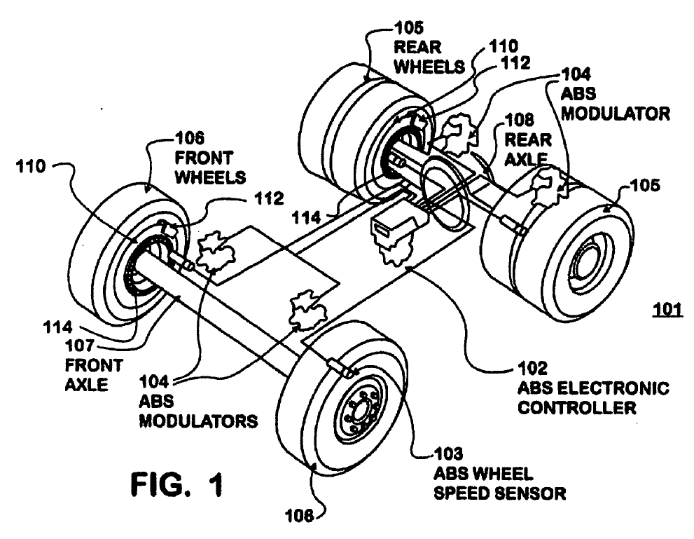

Referring to FIG. 1, system overview of a vehicle 101 equipped with an anti-lock brake system (ABS) is shown without vehicle bodies. The vehicle 101 is illustrative of disk or drum brake systems and has rear wheels 105 mounted on opposite outside ends of a rear axle 108. Front wheels 106 are similarly mounted from the opposite outside ends of a front axle 107. A wheel 106 or 105 may comprise one or two tires. Wheels 105 and 106 are mounted for rotation on axles 108 and 107, respectively.

Vehicle 101 in the FIG. 1 sketch shows disk brakes, which in turn include a disk rotor 110 and a caliper 112 on each of the four wheels. The ABS further includes exciter rings 114 associated with each disk rotor 110, ABS wheel speed sensors 103 positioned along the exciter rings 114, ABS modulators 104 controlling the calipers 112 and an ABS electronic controller 102.

ABS wheel speed sensors 103 may sense wheel rotation in a variety of ways. In the subject embodiment this is accomplished by positioning a variable reluctance sensor so that it is stationary with respect to the exciter ring 114, which rotates as part of the disk rotor 110 mounted to the wheel 105 or 106. The variable reluctance sensor 103 has a cylindrical body, the central longitudinal axis of which is aligned with, and normal to, a sensing circle, that is the target for alignment of the sensor 103 on the exciter ring 114. The moving magnetic material, which in the preferred embodiment resemble gear teeth laid out in a circle on a plane, pass in front of the stationary sensor 103, inducing a varying, cyclical voltage, the frequency of which is proportional to the angular velocity of the wheel.

The amplitude, or signal strength produced by the sensor system is a function in several variables, the most important of which is the gap between the tip of the sensor 103 and the exciter ring 114. Larger gaps produce weaker signals. Corrosion has deleterious effects on both the amplitude and consistency of the electrical signal. Since corrosion acts to destroy the dimensional consistency of the exciter ring teeth 116, the electronic consistency of the signal is likewise compromised. In addition, corrosion increases the gap between the tip of the sensor 103 and the exciter ring teeth 116, while simultaneously reducing the gap between the sensor tip and the bottoms of the gaps between the teeth 116, resulting in reduced amplitude of the resulting electrical signal. As corrosion progresses the amplitude and signal quality can be reduced such that they drop below the thresholds necessary for interpretation by ABS systems. This problem is particularly bad with exciter rings 114 cast as one piece with the disk rotor 110.

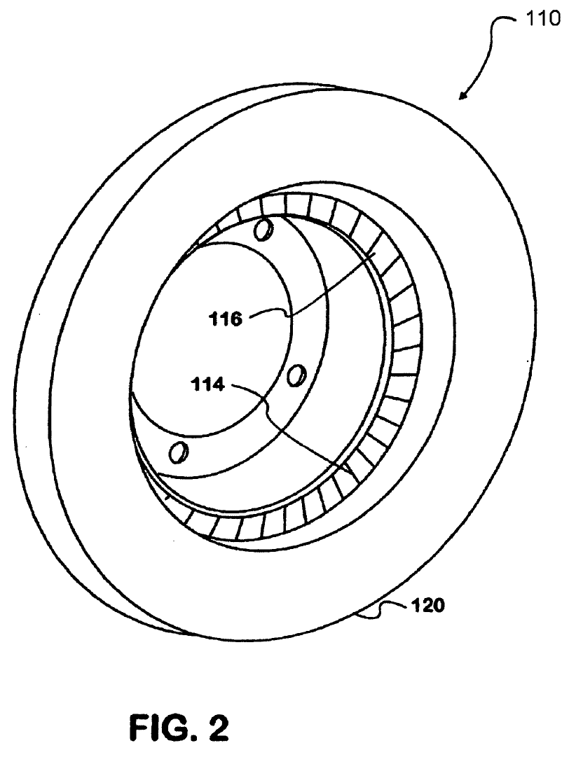

Referring now to FIG. 2 a disk brake rotor 110 comprising a brake rotor body 120, made from a durable material such as cast iron with an exciter ring 114. The teeth 116 of exciter ring 114 lie in the plane of rotation of disk rotor 110. The rotor 110 is selectively coated with highly corrosion resistant and wear resistant coating material such as chrome-nickel-iron alloys such as stainless steel, or ceramic oxides or some combination. The coating only need be applied in the anti-lock brake system exciter ring area 114 of the rotor 110. A thermal spray such as flame spray, plasma-arc spray, or electric spray arc that forms a strong bond with the exciter ring base material, will apply the coating to the substrate material of the exciter ring 114. As described in the Metals Handbook (Volume 5, Ninth Edition, Published by American Society for Metals, Metals Park, Ohio), thermal spray is a generic term for a group of commonly used processes for depositing metallic and non-metallic coatings. The description from the Metals Handbook is incorporated by reference into this specification. These processes, sometimes known as metallizing, include flame spray, plasma-arc spray, and electric arc spray. The thermal sprayed exciter rings 114 will be resistant to corrosion and hence resistant to degraded performance.

While the invention is shown in only one of its forms, it is not thus limited but is susceptible to various changes and modifications without departing from the spirit and scope of the invention.

1. A brake system comprising:
a rotor for rotation about an axis;
an exciter ring portion of said rotor being made of magnetic substrate material; and
said exciter ring having been thermal spray coated.

2. The brake system as set forth in claim 1 wherein said exciter ring coating comprising a chrome-nickel-iron alloy.

3. The brake system as set forth in claim 2 wherein said alloy coating is a stainless steel.

4. The brake system as set forth in claim 1, said exciter ring coating comprising a ceramic oxide.

5. The brake system as set forth in claim 2, said ceramic oxide coating is aluminum oxide.

6. A mobile vehicle comprising:
at least two axles with each axle having at least two wheels engaged thereto;
an anti-lock brake electronic controller;
an anti-lock brake sensor positioned with respect to the wheels engaged to each axle;
each wheel for at least a first axle comprising a rotor;
an exciter ring portion of said rotors being made of magnetic substrate material; and
said exciter rings having been thermal spray coated.

7. The vehicle as set forth in claim 6 wherein said exciter ring coating comprising a chrome-nickel-iron alloy.

8. The vehicle as set forth in claim 7 wherein said alloy coating is a stainless steel.

9. The vehicle as set forth in claim 6, said exciter ring coating comprising a ceramic oxide.

10. The vehicle as set forth in claim 9, said ceramic oxide coating is aluminum oxide.
